(19) United States
(12) Patent Application Publication
(10) Pub. No.: US 2019/0277651 A1
(43) Pub. Date: Sep. 12, 2019

(54) TECHNIQUES AND ARCHITECTURES FOR PROACTIVELY PROVIDING OFFLINE MAPS

(71) Applicant: salesforce.com, inc., San Francisco, CA (US)

(72) Inventor: Amey Ruikar, San Francisco, CA (US)

(21) Appl. No.: 15/915,781

(22) Filed: Mar. 8, 2018

(51) Int. Cl. G01C 21/36; G01C 21/28

(52) U.S. Cl. CPC G01C 21/3691; G01C 21/3676; G01C 21/28; G01C 21/362

(57) ABSTRACT

Providing offline map functionality. A geographic route from a geographic starting location to a geographic destination location is determined. A determination of whether wireless data coverage is unavailable for at least a portion of the geographic route is made. At least one offline map segment for the portion of the geographic route for which wireless data coverage is unavailable is downloaded to a mobile electronic device prior to the mobile electronic device arriving in the portion of the geographic route for which wireless data coverage is unavailable.

### TECHNICAL FIELD

Embodiments relate to techniques for managing maps utilized by mobile devices. More particularly, embodiments relate to techniques for more efficiently and effectively providing offline maps to cellular devices such as mobile smartphones, for example.

### BACKGROUND

Mobile cellular devices, for example, smartphones, tablets, wearable devices, commonly provide maps with routing/direction functionality. This map functionality works well in areas with strong signals, but in areas where signals are weak or non-existent, the mapping functionality is not available. Current solutions require users to download multiple maps, which requires planning and use of memory capacity on the mobile device to be used.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an example map with routes from a selected starting point to a selected destination.

FIG. 2 is a flow diagram of one embodiment of a technique for proactively providing one or more offline maps.

FIG. 3 is an example map with routes from a selected starting point to a selected destination that includes cellular coverage information.

FIG. 4 illustrates regions that can be recursively grouped.

FIG. 5 is a block diagram of one embodiment of an electronic system.

FIG. 6 is a block diagram of one embodiment of an agent to proactively provide offline map segments.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

As discussed above, map applications (e.g., GOOGLE maps, APPLE maps, WAZE) are commonly used to determine a route from a source/starting point to a destination. These map applications typically optimize the route based on time or distance. However, routes can pass through areas with little or no cellular coverage (e.g., national parks, deserts, canyons). As discussed above, current solutions to this problem require a user to select and download maps (or map segments) to have map/navigation information in areas of weak or no cellular signal.

However, users may not be aware of the areas with little or no cellular coverage. Thus, user may discover lack of functionality when it is too late to download the relevant maps (or map segments). Sometimes, even when a cellular signal is available, the signal is too weak or the bandwidth is too limited to download maps (or map segments) for offline use. While the techniques are described herein with respect to cellular data coverage, these techniques are equally applicable to any other wireless data networks.

Described herein are techniques to proactively acquire maps (or map segments) corresponding to areas with limited coverage before the device reaches those areas in order to provide a seamless map/navigation experience.

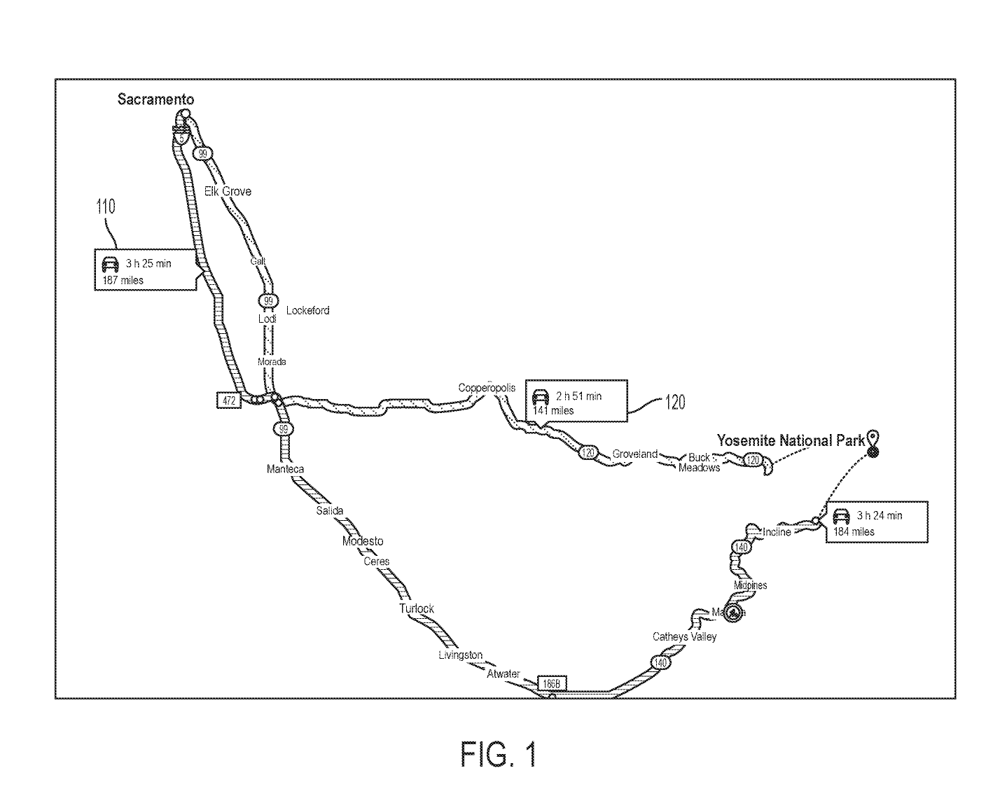

FIG. 1 is an example map with routes from a selected starting point to a selected destination. The example map of FIG. 1 illustrates a starting location of Sacramento, Calif. and a destination of Yosemite National Park in California; however, the techniques described herein can be applied to any type or scale of map.

Typically, map applications provide multiple routes (e.g., 110, 120) with contextual information (e.g., distance, time) to provide a user additional information to select the desired route. In the example of FIG. 1, route 110 is the selected route and route 120 is the alternate route.

As described in greater detail below, the route can be analyzed to determine if any of the regions lack sufficient cellular data coverage (e.g., weak signal, no signal, intermittent connectivity, unknown status, outages) to provide complete map application functionality. In one embodiment, for one or more regions that lack sufficient cellular data coverage, map data that can be used without cellular data (i.e., offline) can be downloaded before the device reaches the region. In one embodiment, the map application can share some or all of the data available offline with other apps on the mobile device, for example, a restaurant app, a banking app, so that the functionality of those apps can also be available in regions that lack sufficient cellular data coverage.

Continuing the example of FIG. 1, in one embodiment, when a user is connected to a Wi-Fi network at (or near) the starting point, the map app (or other agent on the mobile device) can analyze the selected route (e.g., 110 or 120) and determine if the route passes through an area that may lack sufficient cellular data coverage. This information can be obtained, for example, from cellular providers, crowdsourcing, and/or other strategies. In one embodiment, map information for the uncovered areas can be downloaded to the mobile device before the mobile device reaches the uncovered areas.

In one embodiment, in response to any route changes (e.g., automatic rerouting, manual selection of a route), the map app (or other agent) can perform the analysis again, in whole or in part, to determine if a different number and/or different set of offline maps are required.

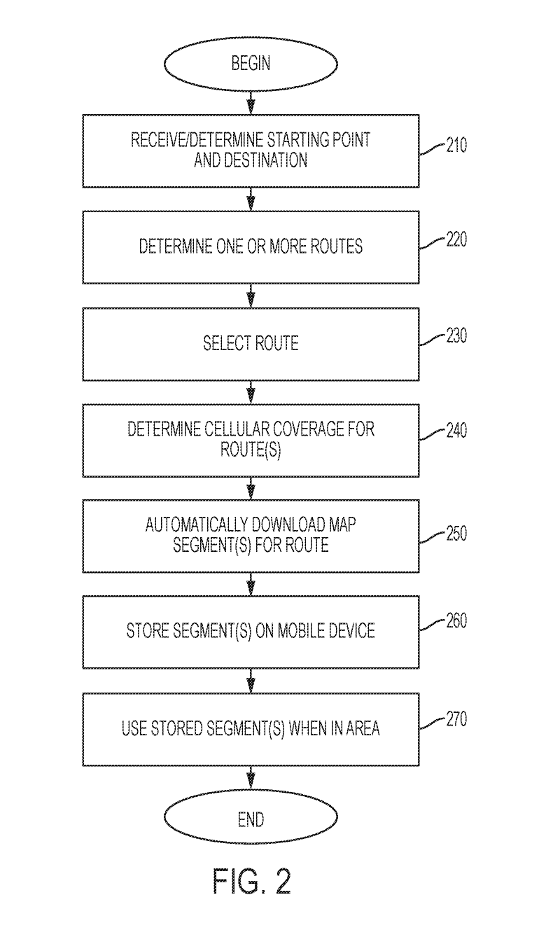

FIG. 2 is a flow diagram of one embodiment of a technique for proactively providing one or more offline maps. In one embodiment, the technique of FIG. 2 is performed utilizing a mobile cellular device (e.g., smartphone, tablet, wearable device); however, this technique can also be performed by and/or shared with other devices (e.g., desktop computers, laptop computers, automobiles).

In one embodiment, starting and ending points for a route are provided, 210. This can be accomplished by, for example, a user entering one or more addresses and/or use of location services with a mobile cellular device (e.g., smartphone). This can happen through a graphical user interface (GUI), voice recognition, global positioning service (GPS) functionality, etc. Alternatively, the starting location and/or the destination location can be provided in another manner, for example, via text message or other electronic messaging protocol. As another alternative, information corresponding to the route can be provided. Route preferences (e.g., no freeways, no toll roads, minimal stop signs, minimal turns) can also be provided and utilized.

In one embodiment, one or more routes can be determined utilizing the starting location and the destination location, 220, if the route has not already been determined. In various embodiments, additional features and/or locations can be included in the route determination including, for example, waypoints, route preferences, road conditions.

A route is selected, 230, if multiple routes are provided. In the example of FIG. 1, two routes are provided via the GUI and the user can select one of the two routes. Any number of routes can be provided.

In one embodiment, cellular data coverage for the route can be analyzed to determine whether sufficient coverage exists for the route, 240. In one embodiment, cellular coverage information can be obtained from cellular service providers. In another embodiment, cellular coverage information can be obtained through crowd sourcing. Other techniques and/or combinations of techniques can be utilized.

In one embodiment, this information can be shared with other apps on the electronic device. For example, a restaurant or lodging app can be notified that the mobile device will likely be in an area with little or no cellular data coverage and that one or more corresponding map segments will be available in the device memory. In one embodiment, this can cause the other apps to download information (e.g., restaurant reviews, hotel reviews) corresponding to the areas without cellular data coverage.

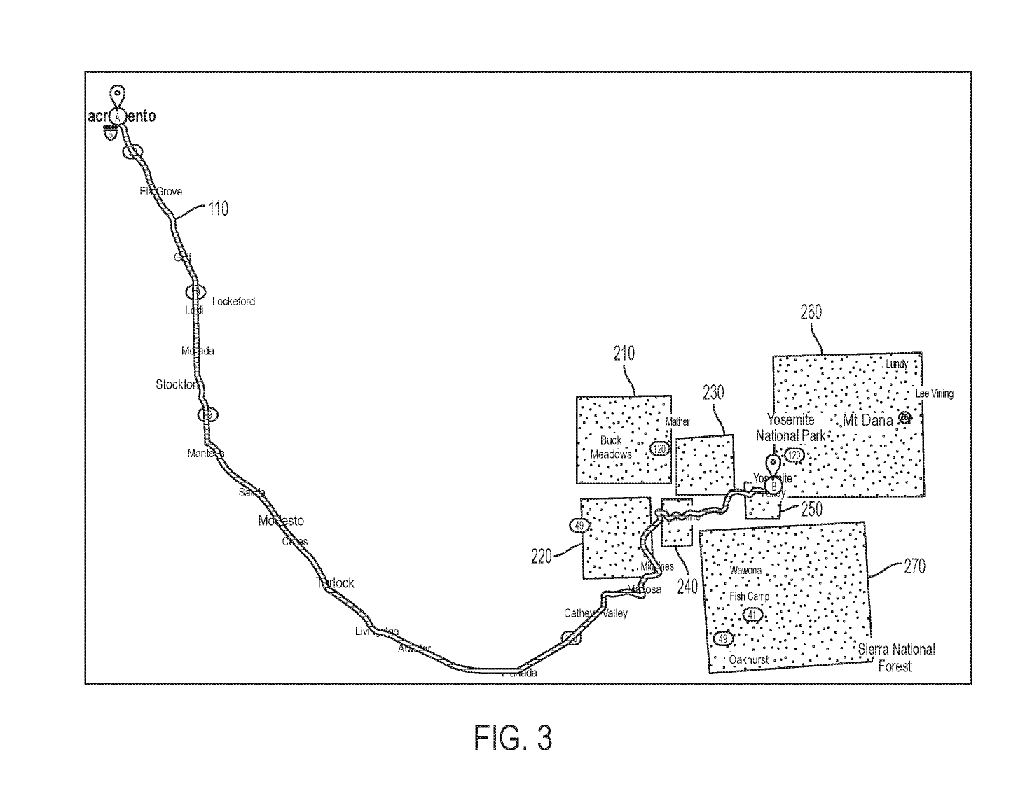

In one embodiment, one or more segments of the relevant map(s) can be downloaded automatically, 250, in response to a determination of insufficient cellular data coverage in the corresponding area. One example and additional detail are provided below with respect to FIG. 3.

The downloaded map segments are stored on the mobile device, 260. The stored map segments are maintained on the mobile device until the mobile device is in one of the regions corresponding to the stored map segments, 270. In one embodiment, the stored map segments can be used whether or not the cellular data signal in the area is insufficient. Alternatively, the stored map segments can be used only if the cellular data signal in the area is insufficient.

FIG. 3 is an example map with routes from a selected starting point to a selected destination that includes cellular coverage information. In the example of FIG. 3, route 110 (as illustrated in FIG. 1 also) has been selected as the route to be used.

In the example of FIG. 3, several regions (e.g., 210, 220, 230, 240, 250, 260, 270) have been identified as having insufficient cellular data coverage. In one embodiment, the map app (or other system component/agent) operates to determine which regions with insufficient cellular data coverage intersect (e.g., 220, 230, 240, 250, 260) with the selected route (e.g., 110).

In one embodiment, the route is maintained in the form of a graph with nodes as intersections and edges as roads. In alternate embodiments, other route representations can be supported. Thus, conceptually, the map app determines which nodes on the path are within the identified regions. Because a route can include hundreds or thousands of nodes, it is not efficient to determine if each node lies within one of the regions. In one embodiment, these calculations are accelerated utilizing R-trees, which are spatial indexes.

In one embodiment, the regions can be grouped together to form larger regions. If this grouping is performed recursively, the result is one large region that includes all relevant smaller regions.

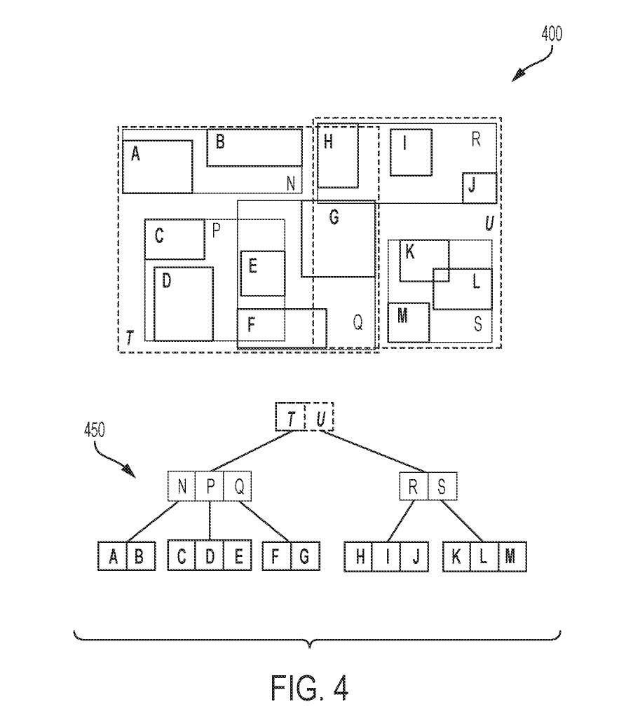

FIG. 4 illustrates regions that can be recursively grouped. In the example of FIG. 4, the representation of regions 400 can be conceptually represented by tree structure 450. In one embodiment, a Euclidean distance calculation can be applied to tree 450 to determine if any of the nodes fall within one of the original regions (e.g., 210, 220, 230, 240, 250, 260, 270).

If a node falls within one of the regions, the corresponding branch can be checked until a leaf is reached, which means the node is within one of the original regions. If the node does not fall in one of the regions, searching of the tree can stop and the processing can move to the next node.

In regions 400, original regions C, D and E can be included within region P, for example. Similarly, original regions L, M and K can be included in region S. Tree structure 450 illustrates the relationship of the original regions in a tree format. In one embodiment, using the analysis and reduction techniques described herein a minimal number of map regions that need to be downloaded can be determined.

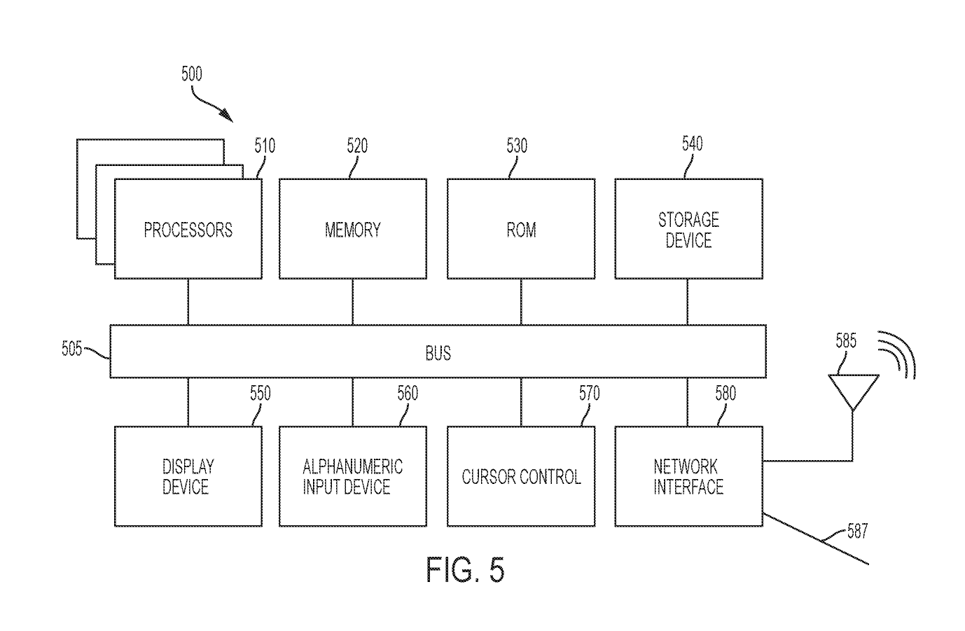

FIG. 5 is a block diagram of one embodiment of an electronic system. The electronic system illustrated in FIG. 5 is intended to represent a range of electronic systems (either wired or wireless) including, for example, laptop computer systems, cellular telephones, smartphones, tablets, wearable computing devices, etc. Alternative electronic systems may include more, fewer and/or different components.

Electronic system 500 includes bus 505 or other communication device to communicate information, and processor 510 coupled to bus 505 that may process information. While electronic system 500 is illustrated with a single processor, electronic system 500 may include multiple processors and/or co-processors. Electronic system 500 further may include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Electronic system 500 may also include read only memory (ROM) and/or other static storage device 530 coupled to bus 505 that may store static information and instructions for processor 510. Data storage device 540 may be coupled to bus 505 to store information and instructions. Data storage device 540 such as a magnetic disk or optical disc and corresponding drive may be coupled to electronic system 500.

Electronic system 500 may also be coupled via bus 505 to display device 550, such as a cathode ray tube (CRT) or liquid crystal display (LCD), to display information to a user. Alphanumeric input device 560, including alphanumeric and other keys, may be coupled to bus 505 to communicate information and command selections to processor 510. Another type of user input device is cursor control 570, such as a mouse, a trackball, or cursor direction keys to communicate direction information and command selections to processor 510 and to control cursor movement on display 550.

Electronic system 500 further may include network interface(s) 580 to provide access to a network, such as a local area network. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

In one embodiment, network interface(s) 580 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 580 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

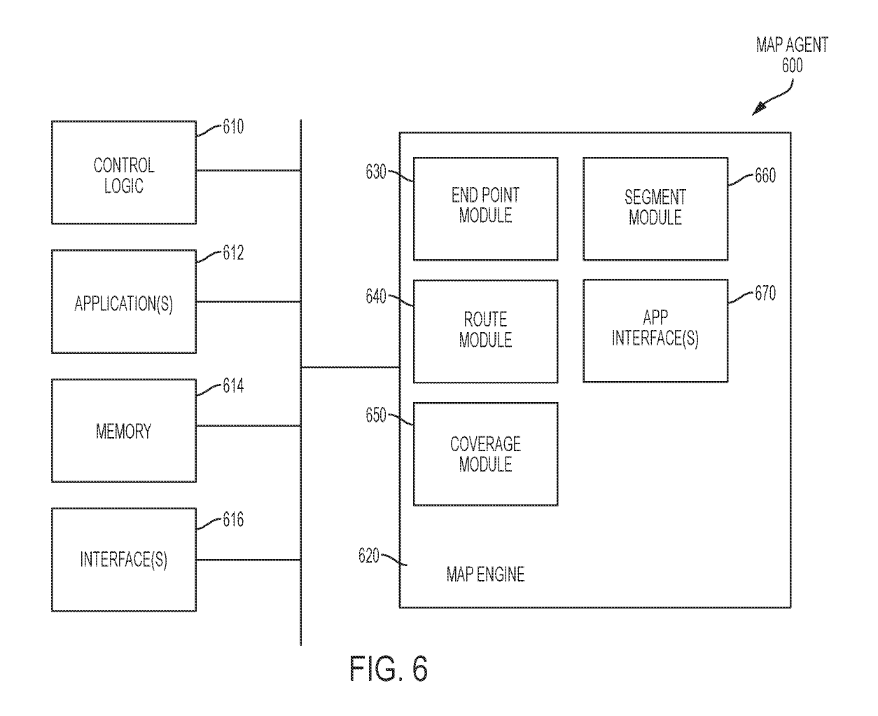

FIG. 6 is a block diagram of one embodiment of an agent to proactively provide offline map segments. The agent of FIG. 6 may provide the functionality discussed above. The agent may exist, for example, within a mobile device that may utilize GPS signals and or cellular data signals to provide mapping functionality on a graphical user interface.

Map agent 600 includes control logic 610, which implements logical functional control to direct operation of map agent 600, and/or hardware associated with directing operation of map agent 600. Logic may be hardware logic circuits and/or software routines. In one embodiment, map agent 600 includes one or more applications 612, which represent code sequence and/or programs that provide instructions to control logic 610.

Map agent 600 includes memory 614, which represents a memory device and/or access to a memory resource for storing data and/or instructions. Memory 614 may include memory local to map agent 600, as well as, or alternatively, including memory of the host system on which map agent 600 resides. Map agent 600 also includes one or more interfaces 616, which represent access interfaces to/from (an input/output interface) map agent 600 with regard to entities (electronic or human) external to map agent 600.

Map agent 600 also includes map engine 620, which represents one or more functions or module that enable map agent 600 to provide the indexing services as described above. The example of FIG. 6 provides several modules that may be included in map engine 620; however, different and/or additional modules may also be included. Example modules that may be involved in providing the map functionality include end point module 630, route module 640, coverage module 650, segment module 660 and app interface(s) 670. Each of these modules may further include other sub-modules to provide other functions. As used herein, a module refers to routine, a subsystem, logic circuit, microcode, etc., whether implemented in hardware, software, firmware or some combination thereof.

In one embodiment, end point module 630 operates to receive a starting point and an end point for a route. This can be accomplished, for example, by receiving user input through a user interface (UI) of a mobile cellular device. In alternate embodiments, the starting point and/or the destination can be received in another manner. For example, a destination can be acquired from a text message and a starting point can be the current location of the device as determined by location services.

In one embodiment, route module 640 communicates with end point module 630 to determine one or more routes between the end points. Various techniques can be utilized to determine the one or more routes. The routes can be prioritized based on various criteria (e.g., shortest distance, shortest estimated time, best cellular data coverage, minimal highways, minimal toll roads, most scenic).

In one embodiment, coverage module 650 operates to determine cellular data coverage for at least one of the routes. Cellular coverage information can be determined, for example, by gathering information from cellular providers, crowdsourcing, use of data collection vehicles/drones/devices, gathering information as a background thread or any combination thereof.

In one embodiment, segment module 660 operates to download one or more map segments to be stored by map agent 600, for example, in memory 614. In one embodiment, segment module 660 operates on information from one or more of end point module 630, route module 640 and coverage module 650 utilizing techniques such as those described above to determine which segments to proactively download. In one embodiment, segment module 660 causes the segment(s) to be downloaded only when connected to a Wi-Fi network. In alternate embodiments, segment module 660 operates to download the segment(s) immediately upon route selection, when a data signal is above a pre-selected threshold, when data rates are minimal, etc.

In one embodiment, use input can be utilized to determine when the segment(s) are to be downloaded. For example, a user may be notified that the selected route includes a region of insufficient cellular data and the user can be asked which criteria to use when determining when to proactively download the map segment(s). In another embodiment, criteria can be selected as preferences to the map app so that the user is not asked each time a route would benefit from proactive segment download.

In one embodiment, app interface(s) 670 allows map agent 600 to communicate with one or more non-map apps to notify the other apps that the device will enter a region without cellular data coverage. In one embodiment, map agent 600 (though segment module 660, for example) can share proactively downloaded map segments with other apps on the device. In another embodiment, app interface(s) 670 can be utilized to notify the other apps so that the other apps can proactively download data that may be useful for those apps in the areas without cellular data coverage. For example, a restaurant listing and review app can be notified of the areas without cellular data coverage and it can acquire restaurant information for those areas. Other types of apps can function in a similar manner.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A non-transitory computer-readable medium having stored thereon sequences of instructions that, when executed by one or more processors, are configurable to cause the one or more processors to:
determine a geographic route from a geographic starting location to a geographic destination location;
determine whether wireless data coverage is unavailable for at least a portion of the geographic route; and
responsive to determining that wireless data coverage is unavailable for at least a portion of the geographic route, automatically download at least one offline map segment for at least one portion of the geographic route for which wireless data coverage is unavailable to a mobile electronic device prior to the mobile electronic device arriving in the portion of the geographic route for which wireless data coverage is unavailable.

2. The non-transitory computer-readable medium of claim 1 wherein determining the geographic route comprises:
receiving the geographic starting location and the geographic destination location through a user interface (UI); and
calculating at least one route between the geographic starting location and the geographic destination location.

3. The non-transitory computer-readable medium of claim 1 wherein determining the geographic route comprises receiving geographic route from another electronic device.

4. The non-transitory computer-readable medium of claim 1 wherein determining whether wireless data coverage is unavailable for at least a portion of the geographic route comprises:
retrieving wireless data coverage information from one or more wireless data providers; and
comparing the wireless data coverage information with the geographic route.

5. The non-transitory computer-readable medium of claim 1 wherein determining whether wireless data coverage is unavailable for at least a portion of the geographic route comprises:
retrieving wireless data coverage information from one or more crowdsource platforms; and
comparing the wireless data coverage information with the geographic route.

6. The non-transitory computer-readable medium of claim 1 wherein determining whether wireless data coverage is unavailable for at least a portion of the geographic route comprises:
retrieving wireless data coverage information from one or more physical wireless data collection platforms; and
comparing the wireless data coverage information with the geographic route.

7. The non-transitory computer-readable medium of claim 1 wherein the mobile electronic device comprises a smartphone.

8. The non-transitory computer-readable medium of claim 1 wherein the mobile electronic device comprises a wearable computing device.

9. The non-transitory computer-readable medium of claim 1 wherein the downloading at least one offline map segment for the portion of the geographic route for which wireless data coverage is unavailable to a mobile electronic device further comprises:
determining one or more map segments corresponding to the at least one portion of the geographic route for which wireless data coverage is unavailable;
recursively merging the one or more map segments to determine at least one higher level map segment; and
downloading the least one higher level map segment for the portion of the geographic route for which wireless data coverage is unavailable to the mobile electronic device prior to the mobile electronic device arriving in the portion of the geographic route for which wireless data coverage is unavailable.

10. A method comprising:
determining a geographic route from a geographic starting location to a geographic destination location;
determining whether wireless data coverage is unavailable for at least a portion of the geographic route;
responsive to determining that wireless data coverage is unavailable for at least a portion of the geographic route, automatically downloading at least one offline map segment for at least one portion of the geographic route for which wireless data coverage is unavailable to a mobile electronic device prior to the mobile electronic device arriving in the portion of the geographic route for which wireless data coverage is unavailable.

11. The method of claim 10 wherein determining the geographic route comprises:
receiving the geographic starting location and the geographic destination location through a user interface (UI); and
calculating at least one route between the geographic starting location and the geographic destination location.

12. The method of claim 10 wherein determining the geographic route comprises receiving geographic route from another electronic device.

13. The method of claim 10 wherein determining whether wireless data coverage is unavailable for at least a portion of the geographic route comprises:
retrieving wireless data coverage information from one or more wireless data providers; and
comparing the wireless data coverage information with the geographic route.

14. The method of claim 10 wherein determining whether wireless data coverage is unavailable for at least a portion of the geographic route comprises:
retrieving wireless data coverage information from one or more crowdsource platforms; and
comparing the wireless data coverage information with the geographic route.

15. The method of claim 10 wherein determining whether wireless data coverage is unavailable for at least a portion of the geographic route comprises:
retrieving wireless data coverage information from one or more physical wireless data collection platforms; and
comparing the wireless data coverage information with the geographic route.

16. The method of claim 10 wherein the mobile electronic device comprises a smartphone.

17. The method of claim 10 wherein the mobile electronic device comprises a wearable computing device.

18. The method of claim 10 wherein the downloading at least one offline map segment for the portion of the geographic route for which wireless data coverage is unavailable to a mobile electronic device further comprises:
determining one or more map segments corresponding to the at least one portion of the geographic route for which wireless data coverage is unavailable;
recursively merging the one or more map segments to determine at least one higher level map segment; and
downloading the least one higher level map segment for the portion of the geographic route for which wireless data coverage is unavailable to the mobile electronic device prior to the mobile electronic device arriving in the portion of the geographic route for which wireless data coverage is unavailable.

19. A system configurable to execute sequences of instructions that, when executed by one or more processors, are configurable to cause the one or more processors to:
determine a geographic route from a geographic starting location to a geographic destination location;
determine whether wireless data coverage is unavailable for at least a portion of the geographic route;
responsive to determining that wireless data coverage is unavailable for at least a portion of the geographic route, automatically downloading at least one offline map segment for at least one portion of the geographic route for which wireless data coverage is unavailable to a mobile electronic device prior to the mobile electronic device arriving in the portion of the geographic route for which wireless data coverage is unavailable.

20. The system of claim 19 wherein determining the geographic route comprises:
receiving the geographic starting location and the geographic destination location through a user interface (UI); and
calculating at least one route between the geographic starting location and the geographic destination location.

21. The system of claim 19 wherein determining the geographic route comprises receiving geographic route from another electronic device.

22. The system of claim 19 wherein determining whether wireless data coverage is unavailable for at least a portion of the geographic route comprises:
retrieving wireless data coverage information from one or more wireless data providers; and
comparing the wireless data coverage information with the geographic route.

23. The system of claim 19 wherein determining whether wireless data coverage is unavailable for at least a portion of the geographic route comprises:
retrieving wireless data coverage information from one or more crowdsource platforms; and
comparing the wireless data coverage information with the geographic route.

24. The system of claim 19 wherein determining whether wireless data coverage is unavailable for at least a portion of the geographic route comprises:
retrieving wireless data coverage information from one or more physical wireless data collection platforms; and
comparing the wireless data coverage information with the geographic route.

25. The system of claim 19 wherein the mobile electronic device comprises a smartphone.

26. The system of claim 19 wherein the mobile electronic device comprises a wearable computing device.

27. The system of claim 19 wherein the downloading at least one offline map segment for the portion of the geographic route for which wireless data coverage is unavailable to a mobile electronic device further comprises:
determining one or more map segments corresponding to the at least one portion of the geographic route for which wireless data coverage is unavailable;
recursively merging the one or more map segments to determine at least one higher level map segment; and
downloading the least one higher level map segment for the portion of the geographic route for which wireless data coverage is unavailable to the mobile electronic device prior to the mobile electronic device arriving in the portion of the geographic route for which wireless data coverage is unavailable.
